(19) United States
(12) Patent Application Publication
(10) Pub. No.: US 2005/0076313 A1
(43) Pub. Date: Apr. 7, 2005

(54) Display of biological data to maximize human perception and apprehension

(76) Inventors: David A. Pegram, Durham, NC (US); Carol Hamilton, Apex, NC (US); Matthew Lawrence, Rolesville, NC (US)

Correspondence Address: Icoria, Inc., 108 T.W. ALEXANDER DRIVE, P O BOX 14528, RTP, NC, 27709-4528, US

(21) Appl. No.: 10/678,661

(22) Filed: Oct. 3, 2003

(51) Int. Cl. G06F 3/00

(52) U.S. Cl. 715/861; 715/859; 715/839; 715/846; 715/837; 715/821; 715/836

(57) ABSTRACT

The present invention provides methods and systems for presenting complex biological data in a display format that facilitates perception and apprehension by an operator. The invention presented herein leverages the bandwidth of the human perceptual system to enable operators of the invention to quickly recognize and identify trends and relationships within the data. The invention is useful in multiple applications, including applications in the agricultural, pharmaceutical, forensic, biotechnology and nutriceutical industries.

This invention was made with United States Government support under Cooperative Agreement No. 70NANB2H3009 awarded by the National Institute of Standards and Technology (NIST). The United States Government has certain rights in the invention.

### FIELD OF THE INVENTION

The present invention provides methods and systems for presenting complex biological data in a display format that facilitates perception and apprehension by a person. The invention leverages the bandwidth of the human visuai perceptual system to enable operators of the invention to quickly recognize and identify trends and relationships within the data. The invention is useful in multiple applications, including applications in the agricultural, pharmaceutical, forensic, biotechnology and nutriceutical industries.

### BACKGROUND

Biological research has in recent years been focused on the genes or genomes of organisms of interest. The focus on genomics research has been of such intensity that the work has been commonly referred to as the “genomics revolution.” Early in the genomics revolution, it was a widely held belief that deciphering the entire genetic codes of humans and other organisms would provide answers to all biological disturbances of importance to mankind by enabling the discovery of the function of each gene. Indeed, huge quantities of genetic data have been gathered, and the complete genomic sequences of numerous organisms have been obtained. Acquiring this vast amount of sequence information has not, however, led to discovery of the functions of most of the sequenced genes.

In parallel with the genome research, protein research (proteomics, protein modeling, protein expression, and the like) has also made significant headway in recent years. However, it has become clear that studying only one type of data exclusively will not provide sufficient information for unraveling the workings of complex diseases or other biological perturbations which stem from gene function. Thus, systems biology is emerging as a preferred approach to integrating and correlating information gained from different biological disciplines to provide a more complete and accurate picture of the biological sample, whether the sample is a tissue, organ, or organism.

Systems biology can be defined as the simultaneous study of complex interactions of multiple levels of biological information including DNA, RNA, protein, biochemical, and phenotype information. Obtaining data from different biological indicators requires a variety of technologies and provides data in various formats. Each technology has its strengths and weaknesses and no single existing technology is sufficient to identify the function of all genes.

Since no solitary technology is the answer to gene function identification, the challenge is to combine data from different technology types in ways that are meaningful. Unfortunately, simultaneously displaying and analyzing data from various sources is wrought with substantial technical problems in data organization. Research technology systems organize data in different ways, and different research technologies use different analysis tools, which ask conceptually different questions.

It is likely that for a majority of genes, a fully understood identification of function will only become possible if data from a variety of sources and technologies can be viewed and analyzed together. Thus, there exists a need for the development of a meaningful way to display and analyze multi-technology-derived data to provide scientists with yet untapped information to aid in the development of new and efficacious agricultural, pharmaceutical, forensic, biotechnology and nutriceutical products.

### SUMMARY

The present invention is useful in creating computer-implemented methods and systems for displaying data by providing an icon representative of a single data measurement; shading the icon with color, where a color hue indicates directionality of change relative to a standard; adjusting color saturation in the shaded icon when the data measurement is changed relative to the standard and where an amount of color indicates degree of change relative to the standard; and displaying the icon generated by one or more of the preceding steps.

Alternatively, the invention presented herein is useful in creating computer-implemented methods and systems for displaying data in a biological context by providing an icon representative of a single data measurement; shading the icon with color, where a color hue indicates directionality of change relative to a standard; adjusting color saturation in the shaded icon when the data measurement is changed relative to the standard and where an amount of color indicates degree of change relative to the standard; selecting a biological context; and displaying the icon generated by one or more of the preceding steps.

Alternatively, the current invention is useful in supplying a biological context in which to display biological data by providing at least one biological context stored as a set of alphanumeric values in a data source; providing at least one type of graphical display of the biological context, wherein the interaction between the data source and the graphical display is dynamic; selecting one biological context type for display; providing at least one icon representative of at least one biological data measurement; and displaying the icon in a way that is representative of a relationship between the icon and the biological context.

### BRIEF DESCRIPTION OF THE FIGURES

FIG. 1 depicts a color circle, or color wheel. A color circle is a circular scheme in which colors are separated according to hue, with complementary colors placed directly across from each other.

FIG. 2 depicts a color solid, or color spindle. A color spindle is a three-dimensional model in which the relationship between hue, brightness, and saturation are depicted.

FIG. 3 illustrates two tiers of technical infrastructure required to support one embodiment of the present invention.

FIG. 4 illustrates dynamic rendering of chemical reaction-based networks from reaction data stored in a data source. Single reactions are rendered as a “hyperedge.” A hyperedge is an edge with multiple source and target nodes that link a reaction substrates and products through two junction nodes and a primary edge. Each junction is then connected via a single primary edge. The hypothetical reaction of FIG. 4 contains three reaction substrates (C, D, and E) and two reaction products (F and G).

FIG. 5 illustrates a primary edge for a given reaction that is labeled using the enzyme commision (EC) number of any enzymes acting as catalysts for the reaction. 1.2.1.6 and 1.3.6.6 represent enzyme commision-labeled enzymes in the reactions shown, with A, C, D, and E being reaction substrates and B, F, and G being reaction products.

FIG. 6 depicts a hierarchical network graph layout of the oxidative phosphorylation pathway emphasizing source and sink nodes.

FIG. 7 depicts a circular network graph layout of the oxidative phosphorylation pathway emphasizing cycles.

FIG. 8 depicts an organic network graph layout of the oxidative phosphorylation pathway.

FIG. 9 depicts an orthogonal network graph layout of the oxidative phosphorylation pathway.

FIG. 10 illustrates one example of how a single icon is used to represent a data measurement for a single compound or metabolite. The icon is shaded with a discrete color hue to indicate the directionality of change relative to a standard, wherein an increase in the amount of the compound or metabolite present is represented by shading the icon with red color, a decrease in the amount of the compound present is represented by shading the icon with green color, and no significant change in the amount of compound present is represented by shading the icon with white or gray (desaturated) color.

FIG. 11 displays BCP and GEP data simultaneously on a biochemical context.

### DETAILED DESCRIPTION OF THE INVENTION

Definitions:

Terms not otherwise defined are intended to have their ordinary meanings.

Identifying a “baseline” or control value is essential to biological experimentation and provides, but is not limited to, a mechanism for distinguishing a perturbed condition from an unperturbed condition. A baseline is used in the invention to standardize data to a common or commonly relevant unit of measure. The term “baseline” is herein used to refer to and is interchangeable with “standard,” “reference,” and “control.” Baseline populations consist, for example, of data from organisms of a particular group, such as healthy or normal organisms, or organisms diagnosed as having a particular disease state, pathophysiological condition, or other physiological state of interest. An example of the use of a baseline is the expression of data measurements as standard deviations from the corresponding baseline mean.

The term “biochemical pathway” or “pathway” refers to a connected series of biochemical reactions normally occurring in a cell, or more broadly, a cellular event such as cellular division or DNA replication. Typically, the steps in such a biochemical pathway act in a coordinated fashion to produce a specific product or products or to produce some other particular biochemical action. Such a biochemical pathway requires the expression product of a gene if the absence of that expression product either directly or indirectly prevents the completion of one or more steps in the pathway, thereby preventing or significantly reducing the production of one or more normal products or effects of the pathway. Thus, if an agent specifically inhibits such a biochemical pathway requiring the expression product of a particular gene, then the presence of the agent stops or substantially reduces the completion of the series of steps in the pathway. Such an agent may, but does not necessarily, act directly on the expression product of the particular gene. A “biochemical pathway network” or “biochemical network” is two or more biochemical pathways which are interrelated by at least one substrate, product, or other common characteristic.

“Brightness” is the psychological perception of light intensity.

Following is terminology used to describe “graphical displays.” A “node” or a “vertex” is a point in a graph or network that terminates a line or arc. An “edge” is a line or arc incident connecting two vertices of a graph or network. A “directed edge” is a line or arc from an initial vertex (or node) to another terminal vertex. A “source” is a vertex with no incoming edges. A “sink” is a vertex with no outgoing edges. A “path” is a sequence of edges connecting two vertices, and a “layout” is an arrangement of vertices and their edges. A “cycle” is a path within a graph or network that begins and ends at the same vertex.

“Hue” is a term used to denote the psychological attribute most clearly corresponding to wavelength of light and is often referred to as “color.” “Hue” and “color” are used interchangeably herein.

For the purpose of this invention, “metabolite” refers to a native small molecule involved in a metabolic reaction required for the maintenance, growth, and function of a cell. However, it is clear to one of skill in the art that data obtained from any chemical component or chemical compound found in a biological sample may be used in the methods and system of the current invention. The precise nature of the chemical compound data, or the technology used to obtain it, does not affect the use of the data in the present invention.

“Morphology” refers to the form and structure of an organism or any of its parts, and is one aspect of a phenotype. Morphometric data refer to macroscopic traits or characteristics of an organism.

“Phenotype” refers to the observable physical, morphological, and/or biochemical/metabolic characteristics of an organism, as determined by genetic and/or environmental factors.

“Saturation” is the psychological attribute of a hue associated with how much of the hue is present.

“Types of data,” as used herein, refer to data derived from different biological indicators. For example, types of data include, but are not limited to, data from DNA, data from RNA, data from proteins, data from metabolites or any chemical components, and data from phenotypic characteristics, such as physical or morphological characteristics. Types of data are obtained by any process or technique known in the art; the process or technique used is immaterial to the present invention. However, the process or technique from which the data emanates may affect how the data are displayed. “Disparate data” are comprised of different types of data.

The present invention provides methods and systems for presenting complex biological data in a display format that facilitates perception and apprehension by a human. The invention presented herein leverages the bandwidth of the human visual perceptual system to enable persons skilled in the art to quickly recognize and identify trends and relationships within the data. The invention is useful in multiple applications, including applications in the agricultural, pharmaceutical, forensic, biotechnology and nutriceutical industries.

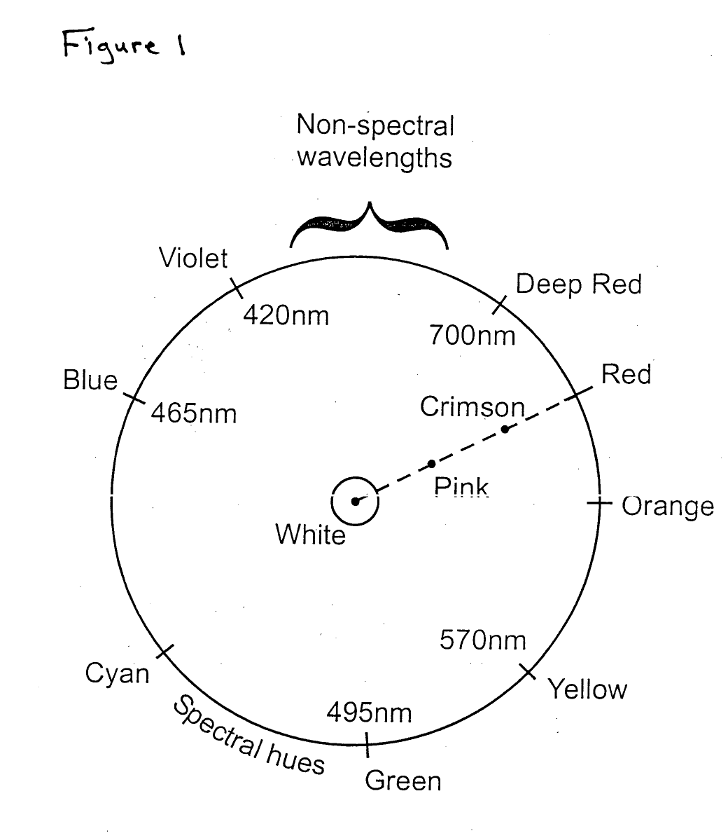

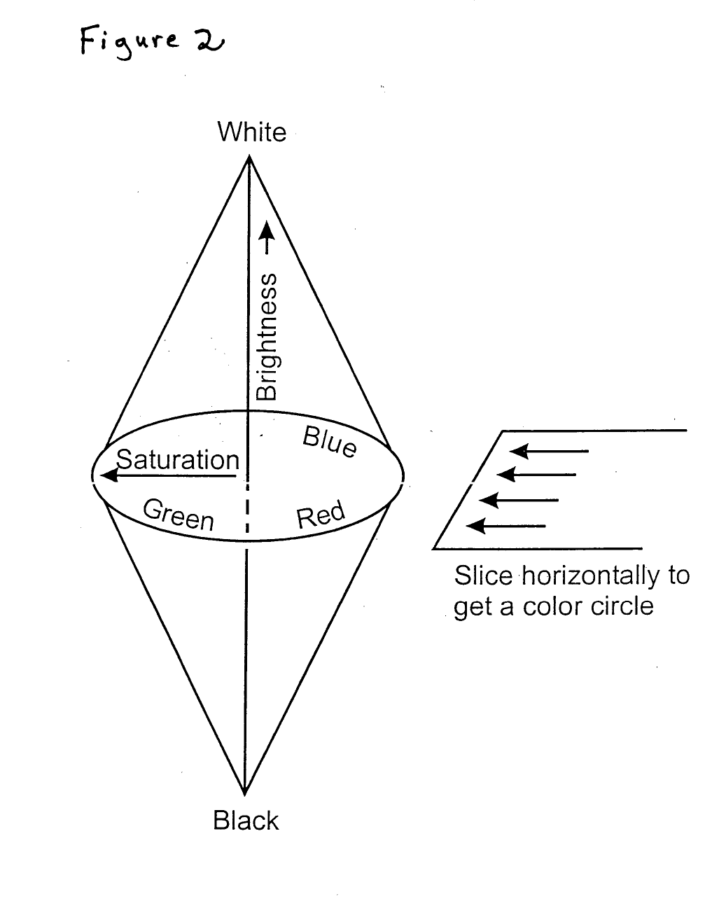

The study of human color perception is based in the scientific disciplines of physiology and psychology. In the human eye, the cones are the retinal receptors that provide the first step of the color response. After the cones receive a stimulus and process the stimulus in a physiological fashion, the human visualization system perceives three attributes of color: hue, saturation, and brightness. Hue refers to the name associated with a color, saturation refers to how much of a color appears to be present, and brightness refers to the perceived amount of light coming from a source. FIG. 1 is a color circle and is representative of the two dimensions of hue and saturation. FIG. 2 is a color solid, which adds to the color circle the dimension of brightness. As illustrated in the color solid of FIG. 2, white and grays are totally desaturated and do not vary in saturation; however, white and grays do vary in brightness. (S. Cohen et al., Sensation and Perception, Harcourt Brace College Publishers, pp.146-176 (1994)).

Technological advances have provided biologists with complex biological data sets that are difficult for humans to comprehend and analyze. Large and complex data sets do not easily lend themselves to recognition and identification of trends and relationships within the data. Thus, there exists a need for development of a meaningful way to display and analyze multi-technology-derived data. The objective of such a visualization tool is to present data to the human observer in a way that is informative and meaningful, yet semi-intuitive and undemanding. When properties of a visual pattern reflect the properties of that which is symbolized, the principle of compatibility has been met. (S. Kosslyn, Elements of Graph Design, W. H. Freeman Publishers, pp. 3-13, (1994)).

Researchers in psychology and vision have discovered a number of visual properties that are “pre-attentively” processed by humans, meaning that there are visual properties immediately detected by the visual system, without the viewer focusing attention on an image to determine whether elements with a given property are present or absent. Two visual features that are pre-attentively processed are form (including line length and spatial grouping) and color (including hue and perceived saturation). (C. Ware, Information Visualization, Morgan Kaufmann Publishers 84-170 (2000); C. Healey et al., 5 ACM Transactions on Modeling and Computer Simulation, pp. 190-221 (1995)).

The present invention provides methods and systems for presenting complex biological data in a display format that facilitates perception and apprehension by a human. The invention presented herein takes advantage of human perception of color hue and color saturation differences and utilizes perceptiveness in distinguishing whether a data measurement has changed relative to a standard, and, if change has occurred, both the degree and the directionality of the change. In addition, the present invention takes advantage of the pre-attentively processed features of line length and spatial grouping by providing simple, defined shapes easily recognizable by a human observer. Not only are methods of data presentation effective in communicating data results immediately (or pre-attentively) to a viewer, the methods and systems of the current invention are also useful in circumstances where a scientist wishes to compare a plurality of data measurements to one another in a timely fashion.

Accordingly, the invention provides methods and systems for displaying data by providing an icon representative of a single data measurement; shading the icon with color, where a color hue indicates directionality of change relative to a standard; adjusting color saturation in the shaded icon when the data measurement is changed relative to the standard and where an amount of color indicates degree of change relative to the standard; and displaying the icon generated by one or more of the preceding steps. Methods and systems for a data display format that maximizes human perception and apprehension are useful in numerous applications, such as: determining gene function; identifying and validating drug and pesticide targets; identifying and validating drug and pesticide candidate compounds; profiling of drug and pesticide compounds; predicting the toxicological impact of a drug or pesticide compound; producing a compilation of health or wellness profiles; identifying suites of compounds, proteins, genes, or combinations thereof to act as biomarkers of a biological status; identifying suites of characteristics, including histological, morphological, physical, or any phenotypic traits, in addition to compounds, proteins or genes, or any combination of the aforementioned to act as biomarkers of a biological status; determining compound sites of action; identifying unknown samples; and numerous other applications in biological science industries.

Thus, in one embodiment, the computer-implemented methods and systems of the present invention for displaying data are comprised of: (a) providing an icon representative of a single data measurement; (b) shading the icon with color, wherein color hue indicates directionality of change relative to a standard; (c) adjusting color saturation in the shaded icon when the single data measurement is changed relative to the standard, wherein amount of color indicates degree of change relative to the standard; and (d) displaying the icon generated by steps (a) through (c) singularly or with a plurality of icons generated by steps (a) through (c).

In one embodiment, each data measurement is provided as a rectangular icon. In yet another embodiment, the rectangular icon has a first pair of parallel sides longer than a second pair of parallel sides. In another embodiment, the rectangular icon is horizontally oriented. In still another embodiment, the rectangular icon is provided as a square. In a further embodiment, the square icon is displayed with one or more additional square icons in a vertically stacked representation as a composite icon. In yet another embodiment, rectangular icons with a first pair of parallel sides longer than a second pair of parallel sides and square icons are displayed simultaneously on the same graphical output.

In contrast to other data visualization tools, the icon of the present invention is not stored in a static way. In other words, the icon is not stored as an image file, but is stored as a numeric value in a data source, such as a database. The icon visualization process is performed dynamically at runtime, based on the information provided in the data source. Dynamic performance at runtime is critical to data analysis in the face of huge quantities of data. Data correction and annotation are ongoing processes and the ability to visualize data in an updated system is crucial. Therefore, the current invention bestows a great advantage over static systems by providing a dynamic relationship between the iconic display and the numerical values stored in the data source.

To support the creation of a data visualization tool, proper technical infrastructure must be available. Appropriate computer hardware is supplied, for example, by the Sun Microsystems E420 workgroup server (Sun Microsystems, Inc., Santa Clara, Calif.). Appropriate operating systems include, but are not limited to, Solaris (Sun Microsystems, Inc., Santa Clara, Calif.), Windows (Microsoft Corp., Redmond, Wash.), Mac (Apple Computer, Inc., Cupertino, Calif.), or Linux (Red Hat, Inc., Raleigh, N.C.). Appropriate software applications include, but are not limited to, relational databases such as Oracle 9.0.1 (9i) (Oracle Corp., Redwood Shores, Calif.), DB2 Universal Database V8.1 (IBM Corp., Armonk, N.Y.), PostgreSQL (PostgreSQL, Inc., Wolfville, NS Canada), or SQL Server 2000 (Microsoft Corp., Redmond, Wash.), and software for statistical analyses, such as packages available from SAS (SAS Institute, Inc., Cary, N.C.) or SPSS, Inc. (SPSS, Inc., Chicago, Ill.).

One embodiment of the present invention involves two tiers of technical infrastructure, a server tier and a client tier. In one embodiment, the server tier is an E420 workgroup server (Sun Microsystems, Inc., Santa Clara, Calif.), the operating system is Solaris (Sun Microsystems, Inc., Santa Clara, Calif.), and the database software is Oracle 9.0.1 (9i) (Oracle Corp., Redwood Shores, Calif.). In the same embodiment, the client tier operates under the Windows operating system (Microsoft Corp., Redmond, Wash.). Persons skilled in the art will recognize that there are any number of combinations of technical products available which could be used to support the data visualization tool of the present invention. Certain computer programming languages are well-suited for use in coding the data visualization tool of the current invention. Such languages include Java (Sun Microsystems, Inc., Santa Clara, Calif.), Visual Basic (Microsoft Corp., Redmond, Wash.), and C++ (AT&T Corp., Bedminster, N.J.), as well as any other language deemed to be appropriate by one skilled in the art.

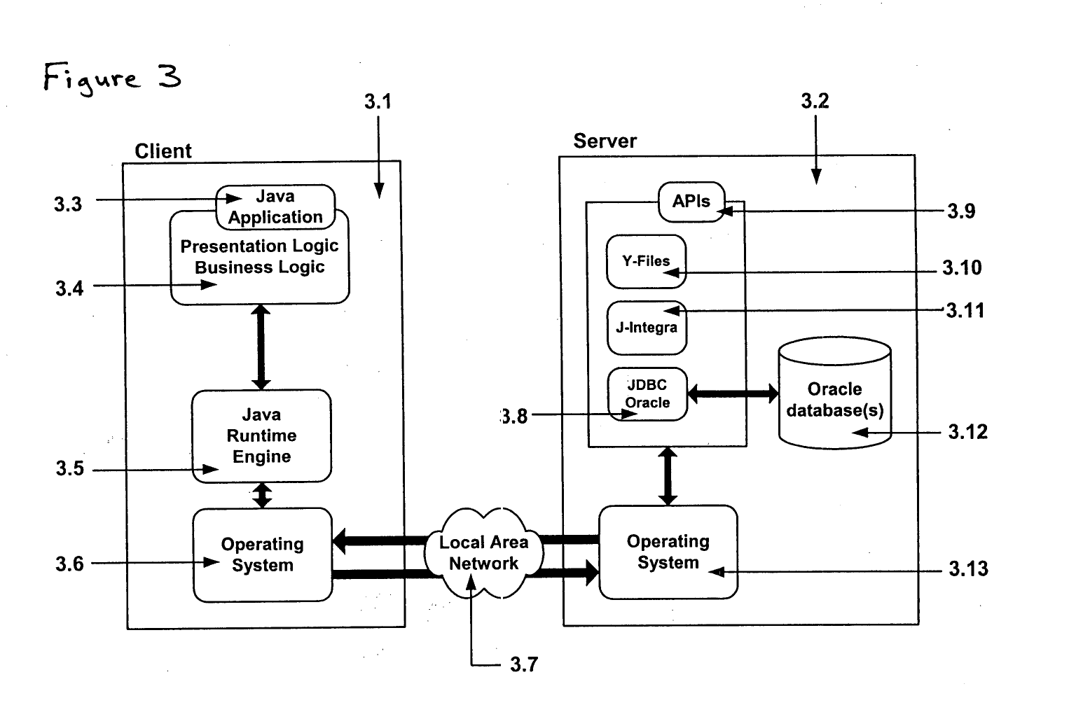

As noted above, in one embodiment the present invention involves two tiers of technical infrastructure, a server tier and a client tier. Illustrated in FIG. 3 is an example of a type of technical infrastructure that can be used to support the methods and systems of the invention. The Java language-based application (3.3), running on the client (3.1), contains both business and presentation logic (3.4). The Java Runtime Engine (JRE, 3.5) interprets and executes the compiled application within the client operating system (e.g. Windows, 3.6). In addition to proprietary presentation and business logic, the client application relies on third party application programming interfaces (APIs, e.g. 3.8, 3.10. and 3.11) for common functionality such as graph rendering (e.g. yfiles (yworks, GmbH, Tubingen, Germany), 3.10), application connectivity (e.g. J-integra, a Java-COM bridge (Intrinsyc Software International, Inc., Vancouver, Canada), 3.11), and database connectivity (e.g. Java database connectivity (JDBC) provided by Oracle, 3.8). Installing APIs (3.9) and the database (3.12) on the server (3.2) provides a scalable solution for information sharing and propagating updates among numerous client applications. Each client communicates with the server-based APIs (3.9) through the local area network (3.7) using common protocols (e.g. TCP/IP) supported by both the client and server operating systems (e.g. Windows (3.6) and Solaris (3.13)).

The data measurements represented by the icons of the current invention may include, but are not limited to, data from gene expression analysis, phenotypic analysis, metabolite or chemical compound analysis, proteomics, histological analysis, 3-D protein structural analysis, and protein expression analysis. Other types of information useful in the methods of the invention include nucleotide sequence data, data from RNAi (RNA interference) or siRNA (small interfering RNA) experiments, single nucleotide polymorphism (SNP) data, any information from scientific literature, clinical chemistry data, and biochemical pathway data, all of which can provide tremendous insight into the workings of complex biological systems.

Gene expression profiling (GEP) analysis refers to a simultaneous analysis of the expression levels of multiple genes. Traditionally, the expression of individual genes was analyzed by a technique called Northern-blot analysis. In a Northern-blot, RNA is separated on a gel, transferred to a membrane, and a specific gene is identified via hybridization to a radioactive complementary probe, usually made from DNA. A technological improvement in the area of GEP has been the development of small 1-2 cm chips used to concurrently determine expression levels of multiple genes from multiple samples. In a gene chip format, probes for the genes of interest are ordered as an array on a glass slide. After hybridization to appropriate samples, gene expression changes are often visualized with colors overlaid on an image of the chip. The color indicates the gene expression level and the location indicates the specific gene being monitored. Other technologies can be used to obtain the same type of gene information, including high-density array spotting on glass or membranes and quantitative reverse transcription and PCR.

Phenotype refers to the observable physical, morphological, and/or biochemical/metabolic characteristics of an organism, as determined by genetic and environmental factors. For example, in an Arabidopsis thaliana plant model system, a phenotype can be described by using distinctly defined attributes such as, but not limited to, number of: abnormal seeds, cotyledons, normal seeds, open flowers, pistils per flower, senescent flowers, sepals per flower, siliques, and stamens. Perturbation of a biological system is often indicated by a phenotypic trait. In humans, a perturbed biological system may result in symptoms of disease such as chest pain, signs such as elevated blood pressure, or observable physical traits such as those exhibited by individuals afflicted with Trisomy 21. A normal phenotype is useful as a reference, standard, or baseline value, against which a physiological status can be measured.

Medical history, examination, and testing techniques are well known to medical practitioners and data derived from the same can be used in practicing the methods and systems of the present invention. For example, in cases where a practitioner is examining a patient to determine the likelihood, existence, or extent of coronary heart disease (CHD), phenotypic traits observed or identified in a clinical setting include, but are not limited to, risk factors such as blood pressure, cigarette smoking, total cholesterol (TC), low density lipoprotein cholesterol (LDL-C), high density lipoprotein cholesterol (HDL-C), and diabetes. (P. G. McGovern et al., 334 New Eng. J. Med., pp. 884-890 (1996)). Additonal phenotypic characteristics and medical history such as body weight, family history of CHD, hormone replacement therapy, and left ventricular hypertrophy are also useful in determining CHD risk. It is common in the medical arts to scale or score a patient's condition based on a set of phenotypic signs and symptoms. For example, predictive models have been described based on blood pressure, cholesterol, and LDL-C categories as identified by the National Cholesterol Education Program and the Joint National Committee on Detection, Evaluation, and Treatment of High Blood Pressure. (P. W. F. Wilson et al., 97 Circulation, pp. 1837-1847 (1998)). Furthermore, predictive outcome models have also been described for patients undergoing coronary artery bypass grafting surgery and percutaneous transluminal coronary angioplasty.

Medical scoring of phenotypic traits is applicable to the assessment of patient well-being pre- and post-therapeutic intervention. For example, Short-Form 36 (SF-36) is gaining acceptance as a generic health outcome assessment form. SF-36 validates health outcomes with eight indices of health and well-being including general health (GH), physical function (PF), role function due to physical limitations (RP), role function due to emotional limitations (RE), social function (SF), mental health (MH), bodily pain (BP), and vitality and energy (VE). Each health object is scored on a 0 to 100 basis with higher scores representing better function or less pain. Other scoring or ranking schemas for identifying and quantifying physiologic and pathophysiologic (phenotypic) states (traits) include, not are not limited, the following: ATP III Metabolic Syndrome Criteria; Criteria for One Year Mortality Prognosis in Alcoholic Liver Disease; APACHE II Scoring System and Mortality Estimates (Acute Physiology and Chronic Health disease Classification System II); APACHE II Scoring System by Diagnosis; Apgar Score; Arrhythmogenic Right Ventricular Dysplasia Diagnostic Criteria; Arterial Blood Gas Interpretation; Autoimmune Hepatitis Diagnostic Criteria; Cardiac Risk Index in Noncardiac Surgery (L. Goldman et al., 297 New Eng. J. Med. 20 (1977)); Cardiac Risk Index in Noncardiac Surgery (A. S. Detsky et al., 1 J. Gen. Int. Med. 211-219 (1986)); Child Turcotte Pugh Grading of Liver Disease Severity; Chronic Fatigue Syndrome Diagnostic Criteria; Community Acquired Pneumonia Severity Scale; DVT Probability Score System; Ehlers-Danlos Syndrome IV (Vascular Type) Diagnostic Criteria; Epworth Sleepiness Scale (ESS); Framingham Coronary Risk Prediction (P. W. F. Wilson et al., 97 Circulation 1837-1847 (1998)); Gail Model for 5 Year Risk of Breast Cancer (M. H. Gail et al., 91 J Nat'l Cancer Inst. 1829-1846 (1999); Geriatric Depression Scale; Glasgow Coma Scale; Gurd's Diagnostic Criteria for Fat Embolism Syndrome; Hepatitis Discriminant Function for Prednisolone Treatment in Severe Alcoholic Hepatitis; Irritable Bowel Syndrome Diagnostic Criteria (A. P. Manning et al., 2 Brit. Med. J. 653-654 (1978)); Jones Criteria for Diagnosis of Rheumatic Fever; Kawasaki Disease Diagnostic Criteria; M. I. Criteria for Likelihood in Chest Pain with LBBB; Mini-Mental Status Examination; Multiple Myeloma Diagnostic Criteria; Myelodysplastic Syndrome International Prognostic Scoring System; Nonbiliary Cirrhosis Prognostic Criteria for One Year Survival; Obesity Management Guidelines (National Institutes of Health/NHLBI); Perioperative Cardiac Evaluation (NHLBI); Polycythemia Vera Diagnostic Criteria; Prostatism Symptom Score; Ranson Criteria for Acute Pancreatitis; Renal Artery Stenosis Prediction Rule; Rheumatoid Arthritis Criteria (American Rheumatism Association); Romhilt-Estes Criteria for Left Ventricular Hypertrophy; Smoking Cessation and Intervention (NHLBI); Sore Throat (Pharyngitis) Evaluation and Treatment Criteria; Suggested Management of Patients with Raised Lipid Levels (NHLBI); Systemic Lupus Erythematosis American Rheumatism Association ll Criteria; Thyroid Disease Screening for Females More Than 50 Years Old (NHLBI); and Vector and Scalar Electrocardiography.

Still other phenotypic traits could be observed or identified by x-ray; cardiac and vascular angiography; electrocardiography; blood pressure (BP) examination; pulse; weight and height; ideal body weight or BMI; retinal examination; thyroid examination; carotid bruits; neck vein examination; congestive heart failure (CHF) signs; palpable intercostal pulses; cardiovascular examination traits including, but not limited to, S4 gallop, tachycardia, bradycardia, heart sounds, aortic insufficiency, murmur, and echocardiography; abdominal examination; genitourinary examination; peripheral vascular disease examination; neurologic examination; and skin examination. In addition to standard x-ray technologies, numerous imaging techniques are also useful in observing and identifying phenotypic traits including, but not limited to, ultrasound, computer axial tomography (CAT), magnetic resonance imaging (MRI), positron emission tomography (PET), single photon emission computed tomography (SPECT), x-ray tranmission, x-ray computed tomography (X-ray CT), ultrasound electrical impedance tomography (EIT), electrical source imaging (ESI), magnetic source imaging (MSI), and laser optical imaging.

Metabolite or biochemical analysis (also referred to as biochemical profiling or BCP) refers to an analysis of organic, inorganic, and/or bio-molecules (hereinafter collectively referred to as “small molecules”) of a cell, cell organelle, tissue and/or organism. It is understood that a small molecule is also referred to as a metabolite. Techniques and methods employed to separate and identify small molecules, or metabolites, include but are not limited to: liquid chromatography (LC), high-pressure liquid chromatography (HPLC), mass spectroscopy (MS), gas chromatography (GC), liquid chromatography/mass spectroscopy (LC-MS), gas chromatography/mass spectroscopy (GC-MS), nuclear magnetic resonance (NMR), magnetic resonance imaging (MRI), Fourier Transform InfraRed (FT-IR), and inductively coupled plasma mass spectrometry (ICP-MS). It is further understood that mass spectrometry techniques include, but are not limited to, the use of magnetic-sector and double focusing instruments, transmission quadrapole instruments, quadrupole ion-trap instruments, time-of-flight instruments (TOF), Fourier transform ion cyclotron resonance instruments (FT-MS), and matrix-assisted laser desorption/ionization time-of-flight mass spectrometry (MALDI-TOF MS).

Metabolite or biochemical analysis allows relative amounts of metabolites to be determined in an effort to deduce a biochemical picture of physiology and/or pathophysiology. In one embodiment of the present invention, individual metabolites present in cells are identified and a relative response measured, establishing the presence, relative quantities, patterns, and/or modifications of the metabolites. In a related embodiment of the invention, the metabolites are linked to enzymatic reactions and biochemical pathways. In another embodiment, rather than identifying metabolites, the spectral properties of chemical components in a biological sample are characterized and the presence or absence of the chemical components noted. In a further embodiment of the invention, a metabolic profile is obtained by analyzing a biological sample for its metabolite composition under particular environmental conditions. In yet another embodiment, a metabolic profile may be used as a biomarker to indicate a biological status of a biological sample. In still a further embodiment, a biomarker may be obtained by combining metabolic profile information from a sample with other types of data, such as phenotype or gene expression data, creating a unique set of variables to represent the biological status of the sample.

The methods and systems of the present invention are also useful in conjunction with data derived from histology studies. Histology is the anatomical study of the microscopic structure of animal and plant tissues. Histological analyses include recordation of traits directly observable and recordation of findings from image analysis. In one embodiment, the histological images are in an electronic format. In another embodiment, the histological images are converted to numeric values. In still another embodiment, the numeric values representative of the histological images are subjected to statistical manipulation. All numeric values, whether they are statistically manipulated, can be represented as icons in the methods and systems of the current invention.

In one embodiment of the present invention the data are RNA data (gene expression analysis, or GEP). In another embodiment of the present invention the data are metabolite data (biochemical profiling analysis, or BCP). In yet another embodiment of the present invention the data are phenotype data. In still another embodiment of the present invention the data are histology data. In yet a further embodiment the data are proteomics data. In another embodiment the data are protein structure or protein modeling data. In still a further embodiment of the present invention the data are GEP data and BCP data. In another embodiment of the present invention the data are GEP data and histology data. In another embodiment of the present invention the data are GEP data and phenotype data. In another embodiment of the present invention the data are GEP data and proteomics data. In still another embodiment of the present invention the data are GEP data, histology data, and BCP data. In a further embodiment of the present invention the data are GEP data, histology data, and phenotype data. In yet another embodiment of the present invention the data are GEP data, phenotype data, and BCP data. In another embodiment of the present invention the data are GEP data, phenotype data, proteomics data, and BCP data. In still a further embodiment of the present invention the data are GEP data, phenotype data, histology data, and BCP data, but one skilled in the art will understand that data from any technology or process, or any combination of technologies or processes, may be utilized in the methods and systems of the invention. Further, it is understood by one skilled in the art that data from any biological organism (alive or dead) or part thereof may be incorporated in the methods and systems of the present invention. Suitable biological organisms include, but are not limited to: plants, such as Arabidopsis (Arabidopsis thaliana), corn, and rice; fungal organisms including Magnaporthe grisea, Saccharomyces cerevisiae, and Candida albicans; microorganisms such as bacteria, algae and diatoms; amphibians and reptiles; and mammals, including rodents, rabbits, canines, felines, bovines, equines, porcines, and human and non-human primates.

Suitable sample parts of biological organisms include, but are not limited to, human and animal tissues such as heart muscle, liver, kidney, pancreas, spleen, lung, brain, intestine, stomach, skin, skeletal muscle, uterine muscle, ovary, testicle, prostate, and bone; human and animal fluids such as blood, plasma, serum, urine, mucus, semen, sweat, tears, amniotic fluid, milk; freshly harvested cells such as hepatocytes or spleen cells; immortal cell lines such as the human hepatocyte cell line HepG2 or the mouse fibroblast line L929; human and animal cells grown in culture as three-dimensional culture spheres (e.g. liver spheroids); and plant tissues such as cotyledons, leaves, seeds, open flowers, pistils, senescent flowers, sepals, siliques, and stamens.

In still another embodiment, the methods and systems of the present invention are useful in creating a computer-implemented method for displaying data in a biological context, comprised of: (a) providing an icon representative of a single data measurement; (b) shading the icon with color, wherein color hue indicates directionality of change relative to a standard; (c) adjusting color saturation in the shaded icon when the single data measurement is changed relative to the standard, wherein amount of color indicates degree of change relative to the standard; (d) selecting a biological context; (e) displaying the biological context; and (f) displaying with the biological context the icon generated by steps (a) through (c) singularly or with a plurality of icons generated by steps (a) through (c) in a way that is representative of a relationship between the icon and the biological context.

In one embodiment, the biological context is a biochemical pathways or pathway networks context, including substrates, products, and enzymes (all metabolites) and the genes that encode the metabolites. Biological contexts may include, but are not limited to, KEGG (Kyoto Encyclopedia of Genes and Genomes, Institute for Chemical Research, Kyoto University, Japan), BRENDA (The Comprehensive Enzyme Information System, Institute of Biochemistry, University of Cologne, Germany), ExPASy (Expert Protein Analysis System, Swiss Institute of Bioinformatics, Geneva, Switzerland), or any other information source that provides biological information useful in data analysis. In another embodiment, a signal transductions context or a protein-binding (protein-protein interactions) context, such as cell surface binding, protein kinase reactions (signal transduction), cytokine binding (signal transduction), or antibody binding, is provided. In another embodiment, a cellular organelle context, such as a mitochondrial context, a cellular context, a tissue context, an organ context, an organ system context, or an entire organism context, is provided. In another embodiment, a chromosomal context, such as genes or metabolites represented on a chromosome map of a particular organism, is provided. In another embodiment, an image context is provided, such as computed axial tomography (CAT) scan, magnetic resonance imaging (MRI), a histology image such as a section of an organism, organ or tissue, a depiction of a human or animal body, a depiction of a human or animal tissue, organ, or organ system, a depiction of a leaf, a root, a stem, a flower, a seed, an entire plant, or any image of an organism or any part thereof. In yet another embodiment, a protein structure or model context is provided, such as the structure of an enzyme complex, on which genes are superimposed. In another embodiment, a context of global architecture of genetic interactions on protein networks is provided (O. Ozier et al., 21 Nature Biotech. 490-491 (2003)). It is understood by those skilled in the art that any information source that is electronically accessible may be used in the methods and systems of the invention to provide a context. Potential information sources include, but are not limited to, image files and American Standard Code for Information Interchange (ASCII) text files.

In a further embodiment, the methods and systems of the present invention are useful in creating a computer-implemented method for displaying data in a biological context, comprised of: (a) providing an icon representative of a single data measurement; (b) shading the icon with red, green, or gray color, wherein color hue indicates directionality of change relative to a standard; (c) adjusting color saturation in the red or green shaded icon, wherein amount of color indicates degree of change relative to the standard; (d) selecting a biological context; (e) displaying the biological context; and (f) displaying with the biological context the icon generated by steps (a) through (c) singularly or with a plurality of icons generated by steps (a) through (c) in a way that is representative of a relationship between the icon and the biological context.

Biological context information is stored in a data source, such as a database, in the form of alphanumeric values. The context information of the present invention is not stored as a static set of image files, as is typical of data visualization tools. Instead of static storage of context information, all graphics are rendered anew at runtime, based on the immediate information provided by the data source. Thus, the interaction between the graphical display of the context and the alphanumeric values stored in the data source is dynamic, and any new information can be included in the display of the context as soon as it is stored in the data source. (M. Becker and I. Rojas, 17 Bioinformatics 461-7 (2001)). Dynamic data source storage and visualization capability allows for data analysis in a most up-to-date environment, which keeps discovery processes moving forward as quickly and accurately as possible and allows refreshment of the biological context for the apprehensive scientist. An additional advantage of the dynamic storage of data is that a human viewer can select a plurality of contexts for representation of the same data, giving the viewer utmost flexibility in searching for meaningful data displays. Still a further advantage of the current invention is that user-defined or novel combinations of features from the context can be displayed, as specified by a user. In one embodiment of the present invention, both the icon and the context have a dynamic relationship with their respective data sources, providing for an up-to-date data analysis environment.

The data sources of the current invention may have various structures, depending on the technical requirements in each case. In one embodiment of the invention, information specifying both the icon and the context are stored in the same data source. In yet another embodiment of the invention, information specifying the icon is stored in a first data source, and information specifying the context is stored in a second data source. It is conceivable that an image created by the methods and systems of the current invention could be stored as an image file, particularly if the image was labor-intensive to create.

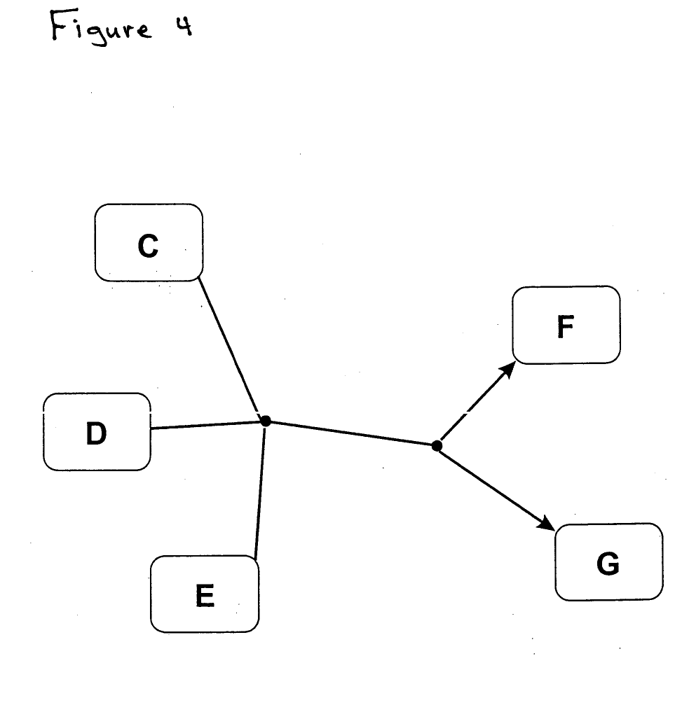

In one embodiment of the current invention, biochemical or metabolic pathway networks may be provided as a biological context. The methods and systems of the instant invention enable dynamic rendering of chemical reaction-based networks from reaction data stored in a data source, such as a database (an exemplary database product is Oracle 9.0.1 (9i), Oracle Corp., Redwood Shores, Calif.). Single reactions are rendered as a “hyperedge.” A hyperedge is an edge with multiple source and target nodes that link reaction substrates and products through two junction nodes and a primary edge. (M. Becker and I. Rojas, supra). Each junction is then connected via a single primary edge. For example, the hypothetical reaction depicted in FIG. 4 contains three substrates (C, D, and E) and two products (F and G).

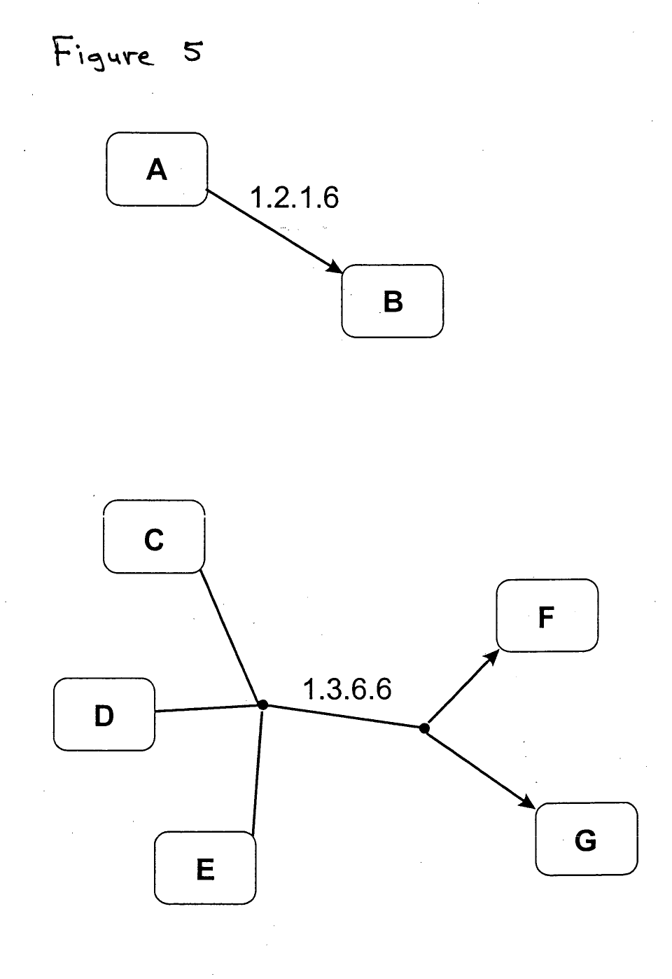

A primary edge for a given reaction is labeled using, for example, the enzyme commision (EC) number of any enzymes acting as catalysts for the reaction. The two EC numbers illustrated in FIG. 5 are 1.2.1.6 and 1.3.6.6, depicted at the site on the reaction pathway where the enzyme is active. Primary edge labels are used by the visualization tool of the present invention so that users can recognize the particular roies a reaction plays in a biological system. The ability to recognize the role of a reaction provides a tool with which to explore other information about the organism of interest.

Typically, reaction-based networks are generated from known biological systems like metabolic pathways. However, by linking common substrates and products among reactions, the current invention can render any set of related reactions as a network. Using the methods and systems of the present invention, any reaction network, including those not previously reported to be related or interconnected, can be visualized for any set of reactions so long as criteria are provided for their selection. Dynamic rendering of images is an advantage of the instant invention that is not available in data visualization tools with static image storage.

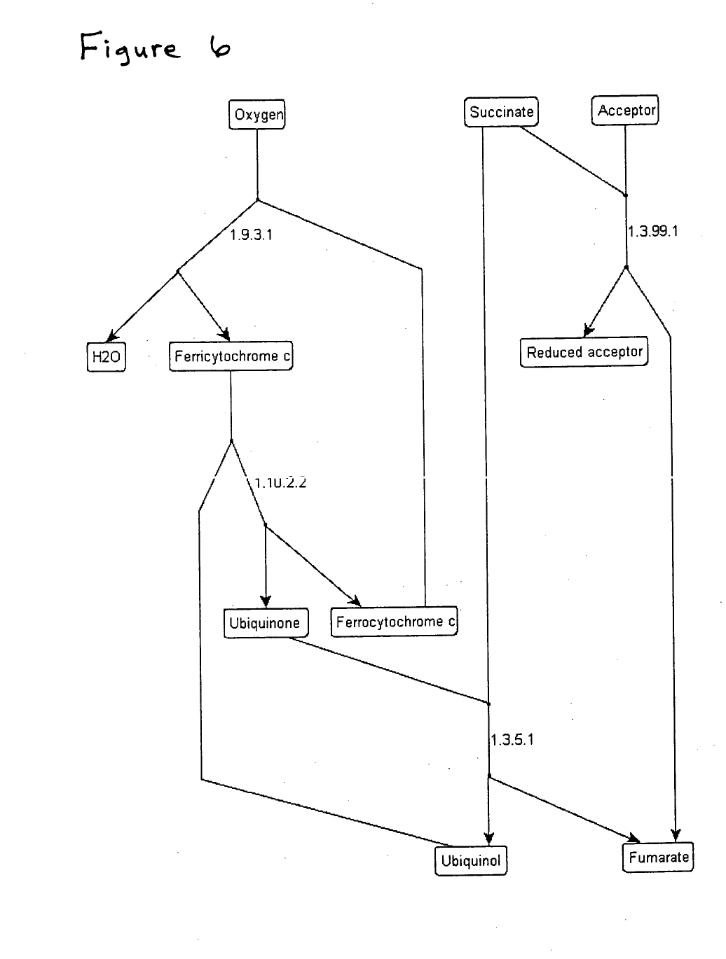

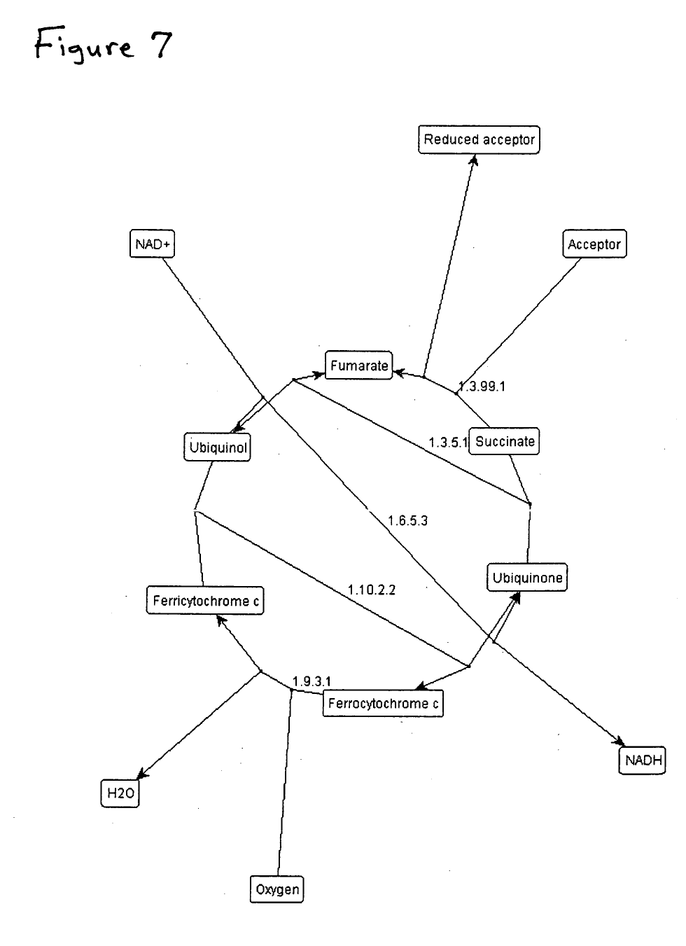

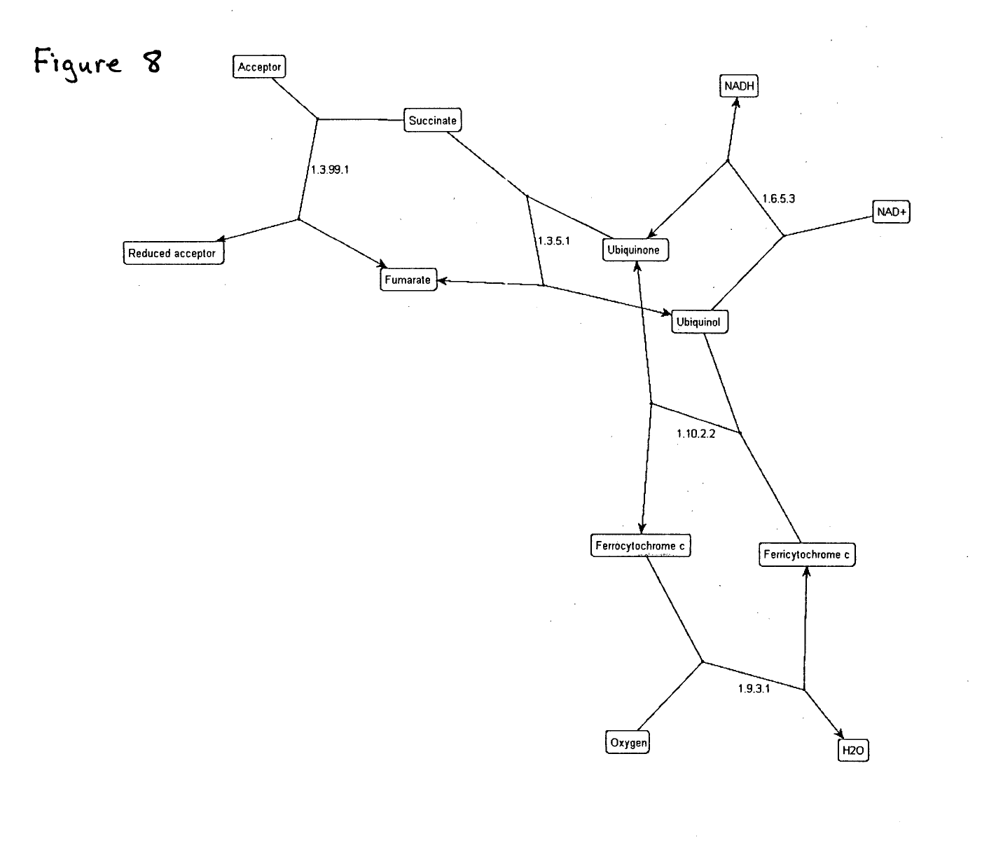

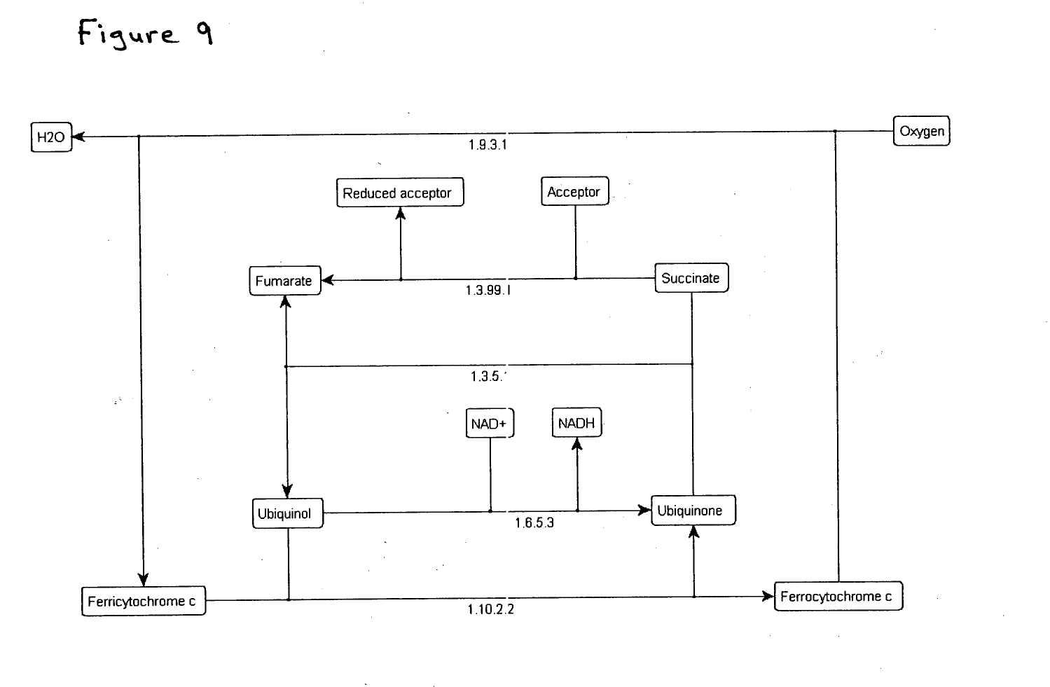

Once the criteria have been provided and the initial network is constructed, the visualization tool can support several graphical layout algorithms, such as, but not limited to, those provided by yFiles (yworks, GmbH, Tubingen, Germany), as selected by a user. Suitable ways of depicting a biochemical or metabolic network include, but are not limited to, a hierarchical network layout emphasizing source and sink nodes (FIG. 6), a circular network layout emphasizing cycles (FIG. 7), an organic network layout (FIG. 8), and an orthogonal network layout, similar to KEGG diagrams (FIG. 9), as described in detail below. Once the network layout is selected, a user can select data to display with the network context. Note that FIGS. 6-9 are all representative of the oxidative phosphorylation pathway, providing a direct comparison of different layout types with respect to the same biochemical pathway.

Hierarchical layout (FIG. 6) is a layout that portrays the precedence relation of directed graphs. A hierarchical layout is ideal for many application areas, especially for processes or flow. Hierarchical layout aims to highlight the main direction or flow within a directed graph. Nodes are placed in hierarchically arranged layers and the ordering of nodes within each layer is selected in such a way that the number of line or edge crossings is small.

Circular layout (FIG. 7) is a layout that portrays interconnected ring and star topologies and is well-suited for applications using networks. A circular layout produces layouts that emphasize group and tree structures within a network. It partitions nodes into groups by analyzing the connectivity structure of the network and displaying the detected groups on separate circles. The circles themselves are arranged in a radial tree layout.

Organic layout (FIG. 8) is a multi-purpose layout that produces clear representations of complex networks. The organic layout is based on the force directed layout paradigm. During layout, graph nodes are considered to be physical objects with mutually repulsive forces, like protons or electrons. Connections between nodes also follow a physical analogy and are considered to be metal springs attached to a pair of nodes. The springs produce repulsive or attractive forces between their endpoints if the springs are too short or too long. The layout simulates physical forces and rearranges the positions of the nodes in such a way that the sum of the forces emitted by the nodes and the edges reaches a (local) minimum. Resulting layouts often expose the inherent symmetric and clustered structure of a graph, a well-balanced distribution of nodes and few edge crossings. The layout is well suited for the visualization of highly connected backbone regions with attached peripheral ring or star structures.

Orthogonal layout (FIG. 9) is a multi-purpose layout that produces clear representations of complex networks. The orthogonal layout is based on the topology-shape-metrics approach and consists of three phases. In the first phase, the edge crossings in the drawing are calculated. The second phase computes the bends in the drawing, and in the third phase, the final coordinates are determined. The orthogonal layout is well suited for medium-sized sparse graphs. It produces compact drawings with no overlaps, few crossings and few bends.

### EXAMPLE 1

### Display of BCP Data Measurements on Chemical Reaction-Based Networks

Data visualization tools often use color to indicate various data characteristics, such as change in comparison to a standard, to exploit color as a visual feature that is pre-attentively processed. Since efficient perception and apprehension of large and complex data sets occurs when the data are presented in forms that are pre-attentively processed by the human observer, the present invention requires use of only two color hues to indicate change relative to a standard. One color hue represents a data measurement which is increased in comparison to the standard. A second color hue represents a data measurement which is decreased in comparison to the standard. If no change can be detected between the data measurement and the standard, desaturated color (white or gray) is displayed. The visualization tool of the present invention uses, in one embodiment, red and green color hues, taken from traditional extremes in gene expression analysis, and does not vary the hue to indicate the amount of change. The present invention is distinct from other data visualization tools, some of which use varying color hues, such as red, orange, yellow, and green, to indicate amount of change. Humans cannot successfully make comparisons between icons when the hue is varied, since perceived color intensity is not uniform for all wavelengths. Importantly, there is no distinct midpoint hue between red and green that is recognized by the human visual system. Many people might claim yellow as a distinct color hue between red and green, but yellow falls closer to green on the color scale than to red. Accordingly, yellow cannot accurately be used to indicate a degree of change midway between red and green. Similar justification exists against using orange as a midpoint. Imprecise hue distinctions may lead to incorrect conclusions during data analysis. (W. S. Cleveland, The Elements of Graphing Data, Wadsworth Publishers, pg. 232 (1985); G. Beroline et al., Technical Graphics Communications (2 ed.), McGraw-Hill Publishers (1997)). Humans cannot effortlessly perceive an ordering to changing hue, and the color scheme of the current invention greatly improves the ability of an observer to perceive data pre-attentively. The present invention uses only two hues as categorical variables, and variances in saturation, not hue, are used to indicate quantitative variables.

A second visual feature that is pre-attentively processed is form, including line length and spatial grouping. The present invention takes advantage of the pre-attentively processed features of line length and spatial grouping by providing simple, defined shapes easily recognizable by a human observer. Not only is the use of form in data presentation effective in communicating data results immediately (or pre-attentively) to a viewer, it is also useful in the event that a scientist wishes to compare a plurality of data measurements to one another in a timely fashion. In the present example, the data measurement is presented as a horizontally-aligned rectangle, which is easily recognized by a human viewer, as described below.

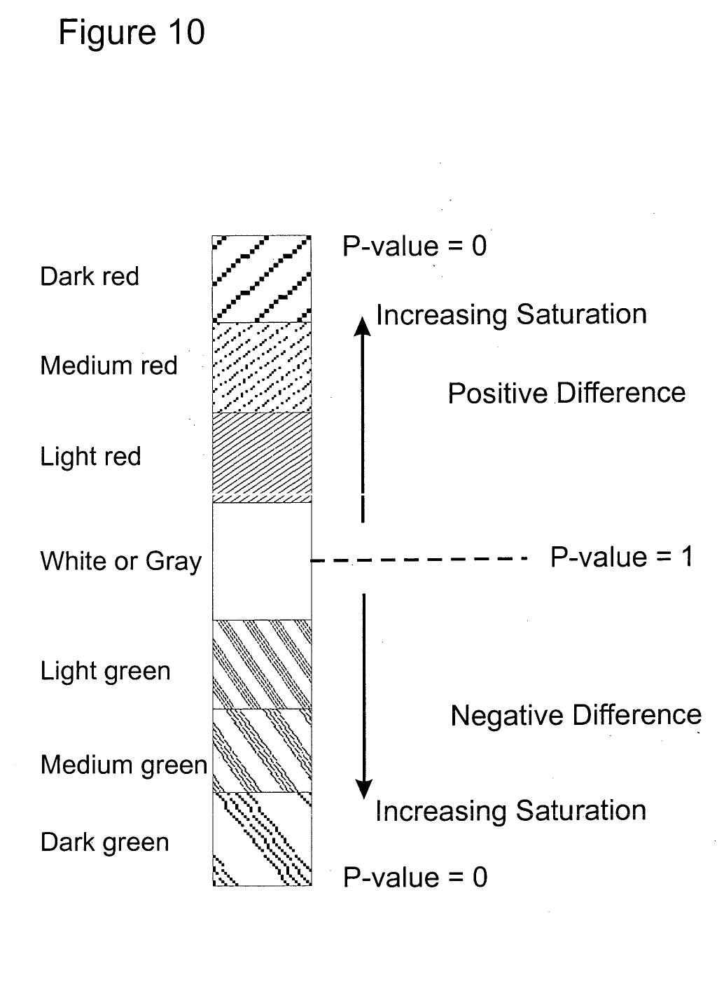

As an example of the methods and systems of the present invention, BCP data is displayed by highlighting icons representative of metabolites or compounds in a biochemical network display. A single icon is used to represent a data measurement for a single compound or metabolite. The icon is shaded with a discrete color hue to indicate the directionality of change relative to a standard, wherein an increase in the amount of the compound or metabolite present is represented by shading the icon with red color, a decrease in the amount of the compound present is represented by shading the icon with green color, and no significant change in the amount of compound present is represented by shading the icon with white or gray (desaturated) color (FIG. 10). The methods and systems of the present invention also provide a feature that allows the human viewer to select the opposite color scheme, wherein an increase is represented by green color and a decrease is represented by red color. The amount of saturation of the red or green color used to shade the icon is adjusted to indicate the amount of change relative to a standard. The amount of change is obtained by calculating the p-value, wherein a smaller p-value indicates that it is less likely that the change occurred by chance. The greater the change relative to the standard (smaller p-value), the higher the color saturation will appear. Thus, a p-value of 1 indicates no change and is represented by an icon shaded white or gray (desaturated), while a p-value approaching 0 is represented by increasing color saturation, whether the change is a positive difference or a negative difference. In the visualization system of the current invention, two types of distinctions must be made by the human observer. The human viewer must perceive two different hues (such as red and green in the present example) and must perceive differing amounts of color saturation within a hue. Limiting iconic highlighting or shading in this manner avoids the confusion that arises when the human visual system makes comparisons between multiple attributes of color, such as direct comparisons of different saturations of different hues.

Using the above-described iconic display system, a human user can apply the methods and systems of the present invention to determine directionality of change, for example, from a group of four icons, by determining which are up-regulated and which are down-regulated. Furthermore, relative quantity of change can be determined, based on comparison of color saturation from one icon to another. It is even possible to determine whether an icon depicting an up-regulation changed more than an icon depicting a down-regulation, despite the fact that such a comparison is between deviations with different directionality.

A context is chosen in which to display the BCP data of the current example. The context is chosen from a selection of contexts supplied by the methods and systems of the present invention. The context, in this example a biochemical network, is displayed on a computer monitor and the data are selected for display. Any compounds depicted in the biochemical network that are measured in the data chosen for display are highlighted in a foreground view. All compounds depicted in the biochemical network that are not measured in the data chosen for display lighten and visually recede into a background view. Biochemical profiling data measurements are displayed by using a single icon to represent a data measurement for a single compound. Compounds are displayed as rectangular icons in a horizontal orientation, with the name of each compound depicted inside the icon. The icon is shaded with a discrete color hue to indicate the directionality of change relative to a standard, wherein an increase in the amount of the compound/metabolite present is represented by shading the icon with red color, a decrease in the amount of the compound present is represented by shading the icon with green color, and no significant change in the amount of compound present is represented by shading the icon with white or gray (desaturated) color. In one example, a screen shot from the oxidative phosphorylation pathway was examined, in which the compound orthophosphate was measured and was observed to be unchanged (depicted by an icon shaded with a white or gray color) in comparison to a standard, and the compound succinate was measured and was observed to be increased (depicted by an icon shaded by a red color) in comparison to a standard. All unmeasured compounds, such as pyrophosphate, triphosphate, and ubiquinol, appear receded into the background of the display. The display format allows the human viewer to immediately discern which compounds in a network are measured, whether the amount of each compound changed, in which direction it changed, the approximate amount of change that occurred, and how that change compares to other compounds within the network. In addition, the display format of the present invention immediately allows the human viewer to determine which related compounds are not yet measured, or at least are not represented in the currently viewed data set, quickly pointing the way to a next step in experimental design or data analysis.

A further useful characteristic of the present invention is the existence of dynamic relationships between both a data measurement and an icon depicting the data measurement, and a context provided as alphanumeric text and a graphical representation thereof. The dynamic visualization process of the current invention not only insures that all graphical representation is current and up-to-date, it also provides flexibility for the human viewer to choose different types of graphical representations (the context) to enhance the information displayed. Different graphical display types portray different features of the data more or less clearly. The ability to examine multiple types of graphical displays representative of the same data empowers the human observer to glean as much information as possible from any particular data.

### EXAMPLE 2

### Display of GEP Data Measurements on Chemical Reaction-Based Networks

Visual representation of GEP data is more complex than display of BCP data as described in Example 1, but many of the same concepts are applied to both data types. Providing a visualization format that is pre-attentively processed is at least as important, if not more so, for GEP data than it is for BCP data, since the display of GEP is more complex. For GEP data, a single square-shaped icon is used to represent a data measurement for a single gene. The icon is shaded with a discrete color hue to indicate the directionality of change relative to a standard, as in Example 1 above. The color saturation of red or green color used to shade the icon is adjusted to correspond with the amount of change relative to a standard, also as in Example 1 above. However, the display of GEP data with a biochemical network is more complicated than display of BCP data, in that multiple genes are often associated with a given EC number in a specific organism, meaning that multiple gene data measurements are often displayed for a single enzyme. Therefore, the multiple square icons for GEP data appear stacked vertically as a composite icon when multiple gene measurements pertain to the same enzyme, with the stack of icons sorted based on the directionality and magnitude of the statistical results. Organizing GEP results in this manner avoids confusion for the human viewer by conforming to the principle of compatibility, which states that the properties of the visual pattern itself should reflect the properties of what is symbolized. (S. Kosslyn, supra). Simply put, up-regulated genes are displayed at the top of the icon while down-regulated genes are shown at the bottom of the icon. Hence, the length of the GEP iconic strip, or composite icon, is directly representative of the number of genes related to a given reaction. Composite icons, which are assemblies of smaller individual icons, are then displayed within a specific biological context, such as a biochemical network. Composite icons allow human users to quickly make comparisons of the number of genes pertaining to a set of reactions simply by comparing the lengths of the icons. It is also easy to determine which reaction has the greatest number of up- or down-regulated genes, due to the two-color system and the sorting of the square elements within the icons.

The display format of the present invention allows the human viewer to immediately discern which genes in a network are measured, which genes pertaining to a single enzyme are measured, whether the amount of message transcribed from each gene changed, in which direction it changed, the approximate amount of change that occurred, and how that change compares to other genes within the enzyme or within the network. In addition, the display immediately allows the human viewer to determine which related genes are not yet measured, or at least are not represented in the currently viewed data set, quickly pointing the way to a next step in experimental design or data analysis.

As in Example 1, a further useful characteristic of the present invention is the existence of dynamic relationships between a data measurement and an icon depicting the data measurement, and between a context provided as alphanumeric text and a graphical representation thereof. The dynamic visualization process of the current invention not only insures that all graphical representation is current and up-to-date, it also provides flexibility for the human viewer to choose different types of graphical representations (the context) for viewing with the data. Different graphical display types portray different features of the data more or less clearly. The ability to examine multiple types of graphical displays representative of the same data empowers the human observer to glean as much information as possible from any particular data.

### EXAMPLE 3

### Display of GEP and BCP Data Measurements on Chemical Reaction-Based Networks

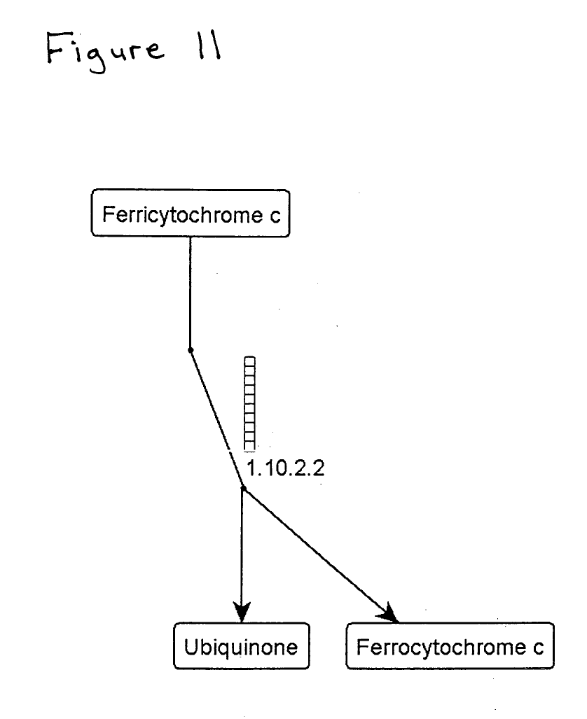

As illustrated in FIG. 11, BCP and GEP data (as in Examples 1 and 2 above) are displayed on a biochemical context simultaneously, providing an interface for a human user to quickly analyze and compare all of the data, even though the data are of two types. Combining data of different types provides a more complete picture of what is happening in a biological system, and enables correlation of all available data.

In the present example, the simultaneous presentation of BCP and GEP data in a biochemical network allows correlation of two data types within a meaningful context. Not only can the human observer quickly ascertain at which points in the network perturbation is occurring, the observer can also more easily pinpoint the source of the perturbation (such as a problem with RNA transcription, RNA translation, protein folding, etc.). One particularly valuable way of utilizing the ability to simultaneously present more than one type of data is to conduct queries based on context of interest rather than by data measurements of interest. A human observer selects a biochemical network of interest (from the choices provided by the visualization tool) and looks at all data relating to that biochemical network, whether it is GEP data, BCP data, proteomics data, and/or any other data types. Simultaneous presentation of a plurality of data types in the present invention is used to identify correlations and relationships previously unattainable by examining individual data types separately.

Published references and patent publications cited herein are incorporated by reference as if terms incorporating the same were provided upon each occurrence of the individual reference or patent document. While the foregoing describes certain embodiments of the invention, it will be understood by those skilled in the art that variations and modifications may be made that will fall within the scope of the invention. The foregoing examples are intended to exemplify various specific embodiments of the invention and do not limit its scope in any manner.

1. A computer-implemented method for displaying data comprising:
a) providing an icon representative of a single data measurement;
b) shading the icon with color, wherein color hue indicates directionality of change relative to a standard;
c) adjusting color saturation in the shaded icon when the single data measurement is changed relative to the standard, wherein amount of color indicates degree of change relative to the standard; and
d) displaying the icon generated by steps (a) through (c) singularly or with a plurality of icons generated by steps (a) through (c).

2. The method of claim 1, wherein the color shading of step (b) is red, green, or gray color.

3. The method of claim 1, wherein the data measurement is stored as a numeric value in a data source.

4. The method of claim 3, wherein the data source is a database.

5. The method of claim 1, wherein the data measurement is selected from the group consisting of a biochemical profiling data measurement, a gene expression profiling data measurement, an histology data measurement, a phenotype data measurement, or a proteomics data measurement.

6. The method of claim 1, wherein the icon is representative of a single metabolite.

7. The method of claim 1, wherein the icon is representative of a single gene.

8. The method of claim 1, wherein the icon is representative of a single gene and all icons representative of genes pertaining to a single enzyme are displayed in a vertically stacked orientation.

9. The method of claim 8, wherein iconic placement in the stack is determined by directionality and magnitude of change as compared to a standard.

10. The method of claim 1, wherein icons representative of two or more data types are displayed simultaneously.

11. The method of claim 3, wherein the interaction between the data source and the iconic display is dynamic.

12. A computer-implemented method for displaying biological sample data, wherein the data are displayed in a biological context comprising:
a) providing an icon representative of a single data measurement;
b) shading the icon with color, wherein color hue indicates directionality of change relative to a standard;
c) adjusting color saturation in the shaded icon when the single data measurement is changed relative to the standard, wherein amount of color indicates degree of change relative to the standard;
d) selecting a biological context;
e) displaying the biological context; and
f) displaying the icon generated by steps (a) through (c) singularly or with a plurality of icons generated by steps (a) through (c) in a way that is representative of a relationship between the icon and the biological context.

13. The method of claim 12, wherein the color shading of step (b) is red, green, or gray color.

14. The method of claim 12, wherein the data measurement is stored as a numeric value in a data source.

15. The method of claim 14, wherein the data source is a database.

16. The method of claim 12, wherein the data measurement is selected from the group consisting of a biochemical profiling data measurement, a gene expression profiling data measurement, an histology data measurement, a phenotype data measurement, or a proteomics data measurement.

17. The method of claim 12, wherein the icon is representative of a single metabolite.

18. The method of claim 12, wherein the icon is representative of a single gene.

19. The method of claim 12, wherein the icon is representative of a single gene and all icons representative of genes pertaining to a single enzyme are displayed in a vertically stacked orientation.

20. The method of claim 19, wherein iconic placement in the stack is determined by directionality and magnitude of change as compared to a standard.

21. The method of claim 12, wherein icons representative of two or more data types are displayed simultaneously.

22. The method of claim 12, wherein the biological context is stored as alphanumeric values in a data source.

23. The method of claim 14, wherein the data source is a database.

24. The method of claim 12, wherein the biological context is represented as a graphical display.

25. The method of claim 24, wherein the graphical display type is selected from the group consisting of hierarchical, organic, circular, and orthogonal.

26. The method of claim 12, wherein the biological context is a biochemical network.

27. The method of claim 14, wherein the interaction between the data source and the iconic display is dynamic.

28. The method of claim 22, wherein the interaction between the data source and the display of the biological context is dynamic.

29. A computer-implemented method for supplying a biological context in which to display biological data comprising:
a) providing at least one biological context stored as a set of alphanumeric values in a data source;
b) providing at least one type of graphical display of the biological context, wherein the interaction between the data source and the graphical display is dynamic;
c) selecting one biological context type for display;
d) providing at least one icon representative of at least one biological data measurement;
e) displaying the icon with the biological context in a way that is representative of a relationship between the icon and the biological context; and
f) optionally, repeating steps (c) through (e).

30. The method of claim 29, wherein the data source is a database.

31. The method of claim 29, wherein the data measurement is selected from the group consisting of a biochemical profiling data measurement, a gene expression profiling data measurement, an histology data measurement, a phenotype data measurement, or a proteomics data measurement.

32. The method of claim 29, wherein the icon is representative of a single metabolite.

33. The method of claim 29, wherein the icon is representative of a single gene.

34. The method of claim 29, wherein the icon is representative of a single gene and all icons representative of genes pertaining to a single enzyme are displayed in a vertically stacked orientation.

35. The method of claim 34, wherein iconic placement in the stack is determined by directionality and magnitude of change as compared to a standard.

36. The method of claim 29, wherein icons representative of two or more data types are displayed simultaneously.

37. The method of claim 29, wherein the graphical display type is selected from the group consisting of hierarchical, organic, circular, and orthogonal.

38. The method of claim 29, wherein the biological context is a biochemical network.

39. A computer-implemented system for displaying data comprising:
a) means for providing an icon representative of a single data measurement;
b) means for shading the icon with color, wherein color hue indicates directionality of change relative to a standard;
c) means for adjusting color saturation in the shaded icon when the single data measurement is changed relative to the standard, wherein amount of color indicates degree of change relative to the standard; and
d) means for displaying the icon generated by steps (a) through (c) singularly or with a plurality of icons generated by steps (a) through (c).

40. The system of claim 39, wherein the color shading of step (b) is red, green, or gray color.

41. The system of claim 39, wherein the data measurement is stored as a numeric value in a data source.

42. The system of claim 41, wherein the data source is a database.

43. The system of claim 39, wherein the data measurement is selected from the group consisting of a biochemical profiling data measurement, a gene expression profiling data measurement, an histology data measurement, a phenotype data measurement, or a proteomics data measurement.

44. The system of claim 39, wherein the icon is representative of a single metabolite.

45. The system of claim 39, wherein the icon is representative of a single gene.

46. The system of claim 39, wherein the icon is representative of a single gene and all icons representative of genes pertaining to a single enzyme are displayed in a vertically stacked orientation.

47. The system of claim 46, wherein iconic placement in the stack is determined by directionality and magnitude of change as compared to a standard.

48. The system of claim 39, wherein icons representative of two or more data types are displayed simultaneously.

49. The system of claim 41, wherein the interaction between the data source and the iconic display is dynamic.

50. A computer-implemented system for displaying biological sample data, wherein the data are displayed in a biological context comprising:
a) means for providing an icon representative of a single data measurement;
b) means for shading the icon with color, wherein color hue indicates directionality of change relative to a standard;
c) means for adjusting color saturation in the shaded icon when the single data measurement is changed relative to the standard, wherein amount of color indicates degree of change relative to the standard;
d) means for selecting a biological context;
e) means for displaying the biological context; and
f) means for displaying the icon generated by steps (a) through (c) singularly or with a plurality of icons generated by steps (a) through (c) in a way that is representative of a relationship between the icon and the biological context.

51. The system of claim 50, wherein the color shading of step (b) is red, green, or gray color.

52. The system of claim 50, wherein the data measurement is stored as a numeric value in a data source.

53. The system of claim 52, wherein the data source is a database.

54. The system of claim 50, wherein the data measurement is selected from the group consisting of a biochemical profiling data measurement, a gene expression profiling data measurement, an histology data measurement, a phenotype data measurement, or a proteomics data measurement.

55. The system of claim 50, wherein the icon is representative of a single metabolite.

56. The system of claim 50, wherein the icon is representative of a single gene.

57. The system of claim 50, wherein the icon is representative of a single gene and all icons representative of genes pertaining to a single enzyme are displayed in a vertically stacked orientation.

58. The system of claim 57, wherein iconic placement in the stack is determined by directionality and magnitude of change as compared to a standard.

59. The system of claim 50, wherein icons representative of two or more data types are displayed simultaneously.

60. The system of claim 50, wherein the biological context is stored as alphanumeric values in a data source.

61. The system of claim 60, wherein the data source is a database.

62. The system of claim 50, wherein the biological context is represented as a graphical display.

63. The system of claim 62, wherein the graphical display type is selected from the group consisting of hierarchical, organic, circular, and orthogonal.

64. The system of claim 50, wherein the biological context is a biochemical network.

65. The system of claim 52, wherein the interaction between the data source and the iconic display is dynamic.

66. The system of claim 60, wherein the interaction between the data source and the display of the biological context is dynamic.

67. A computer-implemented system for supplying a biological context in which to display biological data comprising:
a) means for providing at least one biological context stored as a set of alphanumeric values in a data source;
b) means for providing at least one type of graphical display of the biological context, wherein the interaction between the data source and the graphical display is dynamic;
c) means for selecting one biological context type for display;
d) means for providing at least one icon representative of at least one biological data measurement;
e) means for displaying the icon with the biological context in a way that is representative of a relationship between the icon and the biological context; and
f) means for optionally repeating steps (c) through (e).

68. The system of claim 67, wherein the data source is a database.

69. The system of claim 67, wherein the data measurement is selected from the group consisting of a biochemical profiling data measurement, a gene expression profiling data measurement, an histology data measurement, a phenotype data measurement, or a proteomics data measurement.

70. The system of claim 67, wherein the icon is representative of a single metabolite.

71. The system of claim 67, wherein the icon is representative of a single gene.

72. The system of claim 50, wherein the icon is representative of a single gene and all icons representative of genes pertaining to a single enzyme are displayed in a vertically stacked orientation.

73. The system of claim 72, wherein iconic placement in the stack is determined by directionality and magnitude of change as compared to a standard.

74. The system of claim 67, wherein icons representative of two or more data types are displayed simultaneously.

75. The system of claim 67, wherein the graphical display type is selected from the group consisting of hierarchical, organic, circular, and orthogonal.

76. The system of claim 67, wherein the biological context is a biochemical network.
